(19) United States
(12) Patent Application Publication
(10) Pub. No.: US 2012/0228234 A1
(43) Pub. Date: Sep. 13, 2012

(54) Filter Adapted for use in a Road Gully or Water Course

(76) Inventor: Christopher Price, Newent (GB)

(21) Appl. No.: 13/406,619

(22) Filed: Feb. 28, 2012

Related U.S. Application Data
(60) Provisional application No. 61/450,327, filed on Mar. 8, 2011.

(51) Int. Cl. C02F 1/00; E02B 5/08

(52) U.S. Cl. 210/747.3; 210/154

(57) ABSTRACT

A filter (120) adapted for use in a road gully (100) or water course, the filter being arranged so that, in use, liquid flows through the filter and debris is caught on an outer surface of the filter, and wherein the filter is floatable.

This application claims the benefit of U.S. Provisional Patent Application Ser. No. 61/450,327, the disclosure of which is incorporated herein by reference.

### TECHNICAL FIELD

The present invention relates to a filter adapted for use in a road gully or water course.

### BACKGROUND OF THE INVENTION

Road gullies and water courses, such as outside drainage systems, are susceptible to blocking and require clearing frequently. It is also sometimes desirable to stem the flow of water courses. In the case of gullies, the blockages are usually caused by debris collecting at the base of the pot/well and suction machines, high-pressure water sources, rods or the like are needed in order to clear the gully. Such cleaning methods require expensive equipment and/or can be labour-intensive and time-consuming and so many roadside drainage systems incorporate a gully pot designed to protect downstream sewers and receiving waters by capturing highly polluted sediment deposits. However, such gully pots, particularly when poorly designed and infrequently maintained, are prone to blocking. They can be ineffective in trapping sediment carrying high concentrations of pollutants such as polycyclic aromatic hydrocarbons (PAHs); heavy metals such as lead, chromium, copper, nickel and zinc; road de-icing salts sodium and calcium chloride, and sulphur-bearing smog compounds. Further, run-off in more rural areas, or where maintained gardens are located adjacent to roadways and parking areas, can also contain nitrates, phosphates or pesticides. High rates of inflow into gully pots can flush out existing sediments and trapped oils already contained there. In dry weather they can also become breeding grounds for anaerobic bacteria-micro-organisms able to survive without free oxygen which are a further source of pollution.

With the increasing occurrence of major flooding more and more pollutants escape into the natural environment, which has led to legislation, such as the European Water Framework Directive, which requires water resources to be managed in a more sustainable manner, providing an enhanced level of protection in stormwater quality.

### SUMMARY OF THE INVENTION

Embodiments of the present invention are intended to address at least some of the problems outlined above.

According to a first aspect of the present invention there is provided a filter adapted for use in a road gully or water course, the filter being arranged so that, in use, liquid flows through the filter and debris is caught on an outer surface of the filter, and wherein the filter is floatable.

The filter may be arranged so that, in use, the liquid flows downwards through the filter and debris may be caught on an upper outer surface of the filter. In use, the upper surface of the filter may be located adjacent a grating covering the gully.

The filter will normally be dimensioned to fit inside a road gully. A diameter/width of the filter may generally correspond to a diameter/width of the gully. The filter may be dimensioned so that the filter abuts an inner wall of the gully, but is still movable within the gully. The diameter/width of the filter may be around 375-450 mm. The filter may be generally cylindrical in shape.

The filter may further include at least one arrangement for assisting with removal of the filter from the gully or water course. The removal arrangement may include at least one strap.

The filter may comprise a housing containing a plurality of filter particles. The housing may include a bag formed of porous material, or a net. The filter particles may comprise geosynthetic aggregate. The particles can have dimensions of around 30 mm×30 mm×20 mm. Alternatively, the filter particles may comprise hollow plastic members, e.g. balls.

According to another aspect of the invention there is provided a gully fitted with a filter substantially as described herein.

According to another aspect of the invention there is provided a method of filtering debris in a road gully or water course, the method including fitting a filter substantially as described herein in the road gully/water course.

Whilst the invention has been described above, it extends to any inventive combination of features set out above or in the following description. Although illustrative embodiments of the invention are described in detail herein with reference to the accompanying drawings, it is to be understood that the invention is not limited to these precise embodiments. As such, many modifications and variations will be apparent to practitioners skilled in the art. Furthermore, it is contemplated that a particular feature described either individually or as part of an embodiment can be combined with other individually described features, or parts of other embodiments, even if the other features and embodiments make no mention of the particular feature. Thus, the invention extends to such specific combinations not already described.

### BRIEF DESCRIPTION OF THE DRAWING FIGURES

The invention may be performed in various ways, and, by way of example only, embodiments thereof will now be described, reference being made to the accompanying drawing in which:

FIG. 1 is a schematic diagram of an example filter fitted in a road gully.

### DETAILED DESCRIPTION OF THE INVENTION

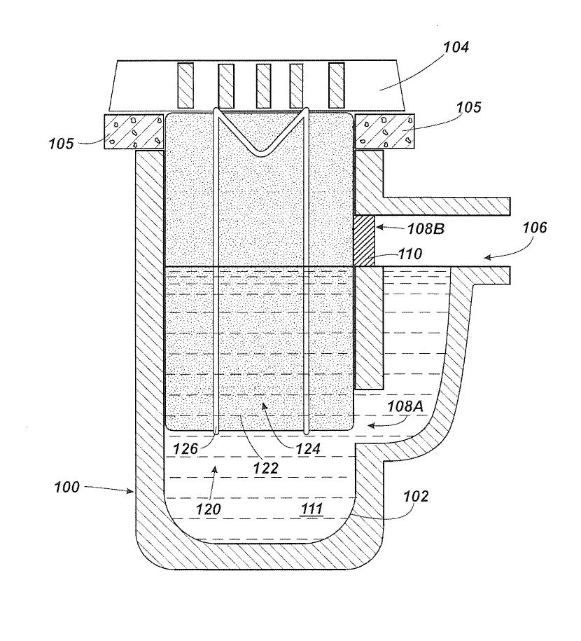

FIG. 1 shows a road gully 100 of the type commonly used in the UK. It includes a main pot/well section 102 and a grating 104 is fitted on the brickwork 105 that surrounds the upper opening of the pot/well. The body of the gully may be formed of plastic, clay, concrete or any other suitable material and typically has a width/diameter of around 375-450 mm and a height of around 750-1200 mm. For versions of the filter system intended for use in water courses, such as streams, drains, etc, the dimensions and design of the product can be varied and can stem the flow, as well as help avoid blockage.

An outlet 106 is in flow communication with the pot/well section 102 by means of a lower aperture 108A and an upper aperture 108B. The outlet will typically have a diameter of around 150 mm and leads to a waste water system. A stopper 110 (connected to the inside of the gully by a chain or the like) may be provided for plugging the upper aperture 108B. During normal cleaning the stopper is not removed, but if debris were found blocking the drain flowing from the gully then the stopper can be removed to allow access for rodding. Liquid, mainly water, flows through the grating 104 and collects in the pot/well and, in the absence of any blockage, is channeled via the outlet 106 to a main sewer network.

FIG. 1 also shows an example of a filter 120 fitted in the gully. The filter includes a housing 122, which may comprise a porous bag made of a permeable geosynthetic, UV-stabilised 115 gsm woven polypropylene raschel netting, for example, which could be made of polyethylene, nylon or polyester or a mix of these types of materials.

The bag is generally cylindrical in shape can have dimensions of around 450 mm diameter and around 1200 mm long. In one embodiment the filter includes a reusable filter “cartridge” about 90 cm long, with a diameter of around 73 cm at the base and around 47 cm at the top, designed to be easily incorporated into existing gully pots or installed in new builds. The base of the bag may include an arrangement, e.g. ties, to allow it to be easily emptied/refilled. The bag is normally only partially filled so as to provide flexibility when installing it through a smaller aperture, but once the gully contains water the buoyancy of the bag floats it up against the grid. Thus, in use, the bag fits snugly within the inner wall of the gully so that there is no (or only a minimal) gap between the outer surface of the filter and the inner surface(s) of the gully wall. The bag is filled with geosynthetic aggregate particles 124, which can have dimensions of around 30 mm×30 mm×20 mm. These particles can comprise non-biodegradable recycled expanded polystyrene (EPS) beads. The EPS beads can act as a filter for storm water, drinking water and wastewater management and are not susceptible to attack by fungus bacteria. They are resistant to most substances which occur naturally in soil, as well as to a wide range of common substances at ambient temperatures, including dilute inorganic acids; gypsum plaster; alcohols; Portland cement; silicone oil, and solvent-free bitumen. In use, water flows through the voids in/between the particles, which are about 50% by volume.

Attached to the bag 122 is a strap 126. In the example the strap comprises a length of material that is attached, e.g. by sewing, to the outer surface of the bag, with portions of the material being provided as loops near the upper surface of the bag.

In use, the gully grating 104 is removed, the filter 120 is lowered into the pot/well section 102 of the gully (whilst unblocked) and then the grating is replaced. During rainfall and the like, surface water will flow through the grating as normal and then downwards through the filter 120 to the base of the pot/well section of the gully. When there is a sufficient amount of water 111 in the base, it will rise and pass out of the gully via outlet 106 as normal. Any debris falling through the grating that is too large to pass through the filter will collect on the upper surface of the filter. As the filter 120 is floatable in water, it will rise/fall in accordance with the amount of water present in the gully, but in general with remain relatively near to the grating 104 even if the base of the pot/well is full. Thus, the filter can be removed easily when required. To remove the filter, the worker takes off the gully grating and pulls out the filter using the handles 126. The filter is reusable and can be replaced in the gully after the debris has been cleaned off. The filter effectively prevents debris falling to the base of the pot/well and makes the cleaning operation easier and quicker.

The skilled person will appreciate that variations to the example filter described above are possible. For example, floatable materials other than geosynthetic aggregate can be used to fill the housing, such as hollow plastic members, e.g. balls. Alternatively, a block of floatable material with small filter channels running through it can be used instead of a bag-like housing full of separate particles. Removal-assisting arrangements other than at least one strap can also be provided, e.g. at least one handle integrally formed on the filter/housing. The filter system offers no nourishment to vegetation and does not attract animal interest. It is not water soluble and typically, even after long term immersion, will not exceed a moisture absorption level of 8-10%. Installation of the filter system can provide the following benefits:
a reduction in installation and maintenance costs
an engineered solution to the entrapment and treatment of pollutants
an aerobic environment to optimise bacterial biodegradation
a functioning grease trap within interceptors
the ability to restrict flow to reduce peaks
the flexibility to fit a range of gully pot dimensions

1. A filter (120) adapted for use in a road gully (100) or water course, the filter being arranged so that, in use, liquid flows through the filter and debris is caught on an outer surface of the filter, and wherein the filter is floatable.

2. A filter according to claim 1, wherein the filter (120) comprises a housing (122) containing a plurality of filter particles (124).

3. A filter according to claim 2, wherein the housing (122) includes a bag formed of porous material or a net.

4. A filter according to claim 2, wherein the filter particles (124) comprise geosynthetic aggregate.

5. A filter according to claim 2, wherein each of the filter particles has dimensions of around 30 mm×30 mm×20 mm.

6. A filter according to claim 4, wherein these particles (124) comprise non-biodegradable expanded polystyrene beads.

7. A filter according to claim 3, wherein the filter particles comprise hollow plastic members, e.g. balls.

8. A filter according to claim 1, wherein the filter (120) is arranged so that, in use, the liquid flows downwards through the filter and debris is caught on an upper outer surface of the filter.

9. A filter according to claim 8, where, in use, the upper surface of the filter (120) is located adjacent a grating (104) covering the gully (100).

10. A filter according to claim 1, wherein the filter (120) is dimensioned to fit inside a road gully (100).

11. A filter according to claim 1, wherein a diameter/width of the filter (120) generally corresponds to a diameter/width of the gully (100).

12. A filter according to claim 1, wherein the filter (120) is dimensioned so that the filter abuts an inner wall of the gully (100), but is still movable within the gully.

13. A filter according to claim 10, wherein a diameter/width of the filter (120) is around 375-450 mm.

14. A filter according to claim 1, wherein the filter (120) is generally cylindrical in shape.

15. A filter according to claim 1, further including at least one arrangement (128) for assisting with removal of the filter from the gully or water course.

16. A filter according to claim 15, wherein the removal arrangement includes at least one strap (128).

17. A gully (100) fitted with a filter (120) according to claim 1.

18. A method of filtering debris in a road gully or water course, the method including fitting a filter (120) according to claim 1 in the road gully (100) or water course.
